(19) United States
(12) Patent Application Publication
(10) Pub. No.: US 2015/0058080 A1
(43) Pub. Date: Feb. 26, 2015

(54) CONTRACT EROSION AND RENEWAL PREDICTION THROUGH SENTIMENT ANALYSIS

(71) Applicant: INTERNATIONAL BUSINESS MACHINES CORPORATION, ARMONK, NY (US)

(72) Inventors: SINEM GUVEN KAYA, YORKTOWN HEIGHTS, NY (US); MATHIAS B. STEINER, YORKTOWN HEIGHTS, NY (US); NIYU GE, YORKTOWN HEIGHTS, NY (US); AMITKUMAR M. PARADKAR, YORKTOWN HEIGHTS, NY (US)

(21) Appl. No.: 14/247,934

(22) Filed: Apr. 8, 2014

Related U.S. Application Data
(60) Provisional application No. 61/869,500, filed on Aug. 23, 2013.

(51) Int. Cl. G06Q 30/02

(52) U.S. Cl. CPC G06Q 30/0202
USPC 705/7.31

(57) ABSTRACT

A method for predicting contract renewal ahead of contract expiration includes receiving comments and interview transcripts by a sentiment analysis program to generate sentiments, where the comments and interview transcripts are received from a plurality of clients who are contractees to one or more service contracts, combining the sentiments with contract assessment survey scores and historical renewal and growth data for the service contracts to generate a contract renewal and growth prediction model, providing a contract that is up for expiration to the predictive model, and providing the comments, interview transcripts, and risk assessment survey scores to the predictive model, where the predictive model outputs a prediction of renewal and growth for the contract up for expiration, and an analysis of root causes for the predictions.

### CROSS REFERENCE TO RELATED UNITED STATES APPLICATIONS

This application claims priority from “Contract Erosion And Renewal Prediction Through Sentiment Analysis”, U.S. Provisional Application No. 61/869,500 of Ge, et al., filed Aug. 23, 2013, the contents of all of which are herein incorporated by reference in their entireties.

### BACKGROUND

1. Technical Field

Embodiments of the present disclosure are directed to predicting contract erosion and renewal risk ahead of contract expiration by taking into account survey results and interview transcripts.

2. Discussion of the Related Art

In the information technology (IT) outsourcing domain, service providers are interested in understanding the reasons and patterns regarding contract renewal decisions well before contract expiration. Various kinds of risk assessments as well as service quality and performance surveys are, thus, conducted throughout the life cycle of a service contract to monitor cues indicating risk of nonrenewal. Client satisfaction (CSAT) is one of such assessments, and typically comprises a survey, in which a client usually provides a numeric satisfaction score for each question, as well as a detailed interview, in which a client is asked to elaborate on their scoring decisions. As CSAT aims to measure the client's perspective in an unbiased fashion, it naturally becomes a useful input when determining contract renewal risk. While a CSAT survey overall score is often used in contract risk assessments, the unstructured textual nature of CSAT interviews may be a limitation for their immediate consumption. This may mean that the detailed insights provided during interviews may often not be an input to risk assessments, unless a low CSAT score warrants a more detailed look at an interview transcript.

CSAT scores typically constitute aggregated information and do not necessarily represent the multitude of risk dimensions captured in an interview. Therefore, a drawback of using survey scores for risk assessment is that they may not necessarily represent the true client sentiment. For example, during a CSAT interview, a client's response to a question may contain more than one (conflicting) sentiment, such as the client is pleased with the response time, but not satisfied with the cost of services. Considering the CSAT score alone would result in critical information, such as client concerns, being lost in a single, aggregated numerical value. As there is no systematic way of capturing such sentiments hidden in an interview transcript, a risk assessment based on a survey score alone may not be as complete. Finally, by using the survey scores alone, it is not possible to identify reasons for non-renewal from historical data.

Even when the intention is to include interview findings in a risk assessment, the unstructured textual nature of interview transcripts often necessitates manual interpretation and summarization, which incur additional time and cost. Further, interpretation might lead to important cues being lost in translation. Summarization may not capture true client sentiments either, as it merely reports the gist of the interview.

### BRIEF SUMMARY

According to an aspect of the disclosure, there is provided a method for predicting contract renewal ahead of contract expiration, including receiving comments and interview transcripts by a sentiment analysis program to generate sentiments, where the comments and interview transcripts are received from a plurality of clients who are contractees to one or more service contracts, combining the sentiments with contract assessment survey scores and historical renewal and growth data for the service contracts to generate a contract renewal and growth prediction model, providing a contract that is up for expiration to the predictive model, and providing the comments, interview transcripts, and risk assessment survey scores to the predictive model, where the predictive model outputs a prediction of renewal and growth for the contract up for expiration, and an analysis of root causes for the predictions.

According to a further aspect of the disclosure, generating sentiments includes providing a first set of comments specific to a first domain, providing a second set of comments specific to a second domain, determining a set of topics for the first domain using the second set of comments as negative examples with respect to the first domain, and determining, for each topic in the set of topics, whether the topic is independent of its domain, where if the topic is independent of its domain, the topic is removed from the set of topics.

According to a further aspect of the disclosure, the method includes using log-likelihood hypothesis testing to determine to which of the first and second domains each the topic belongs.

According to a further aspect of the disclosure, each topic in the set of topics is a noun.

According to a further aspect of the disclosure, the method includes bootstrapping sentiments from the set of topics for the first domain using sentiment scores associated with each topic and the contract assessment survey scores, where if a sentiment associated with a topic is unclear, using contract assessment survey scores to infer the associated assessment.

According to a further aspect of the disclosure, the method includes using machine learning techniques to determine topics from the comments, and to identify sentiments associated with each topic.

According to another aspect of the disclosure, there is provided a method for predicting contract renewal ahead of contract expiration, including receiving comments and interview transcripts by a sentiment analysis program to generate sentiments, where the comments and interview transcripts are received from a plurality of clients who are contractees to one or more service contracts, providing a first set of comments specific to a first domain, providing a second set of comments specific to a second domain, determining a set of topics for the first domain using the second set of comments as negative examples with respect to the first domain, and determining, for each topic in the set of topics, whether the topic is independent of its domain, where if the topic is independent of its domain, the topic is removed from the set of topics.

According to a further aspect of the disclosure, the method includes bootstrapping sentiments from the set of topics for the first domain using sentiment scores associated with each topic and the contract assessment survey scores, where if a sentiment associated with a topic is unclear, using contract assessment survey scores to infer the associated assessment.

According to a further aspect of the disclosure, the method includes combining the sentiments with contract assessment survey scores and historical renewal and growth data for the service contracts to generate a contract renewal and growth prediction model, providing a contract that is up for expiration to the predictive model, and providing the comments, interview transcripts, and risk assessment survey scores to the predictive model, where the predictive model outputs a prediction of renewal and growth for the contract up for expiration, and an analysis of root causes for the predictions.

According to another aspect of the disclosure, there is provided a non-transitory program storage device readable by a computer, tangibly embodying a program of instructions executed by the computer to perform the method steps for predicting contract renewal ahead of contract expiration.

### BRIEF DESCRIPTION OF THE SEVERAL VIEWS OF THE DRAWINGS

FIG. 1 depicts a typical IT outsourcing contract lifecycle and end-to-end risk assessment, according to embodiments of the disclosure.

FIG. 2 illustrates the building and training of predictive models, according to embodiments of the disclosure.

FIG. 3 is an overview of sentiment analysis from unstructured text, according to embodiments of the disclosure.

FIG. 4 is an algorithmic view of a method of sentiment analysis, according to an embodiment of the disclosure.

FIG. 5 illustrates details of a predictive model, according to embodiments of the disclosure.

FIG. 6 is a table depicting example topics with positive sentiments, according to embodiments of the disclosure.

FIG. 7 is a table that shows classification of renewed and non-renewing contracts based on CSAT overall score, according to embodiments of the disclosure.

FIG. 8 is a table that shows classification of renewed and non-renewing contracts based on CSAT scores and client sentiments extracted from CSAT interviews, according to embodiments of the disclosure.

FIG. 9 is a block diagram of an exemplary computer system for implementing a method for predicting contract erosion and renewal risk ahead of contract expiration, according to an embodiment of the disclosure.

### DETAILED DESCRIPTION

Exemplary embodiments of the invention as described herein generally include systems and methods for predicting contract erosion and renewal risk ahead of contract expiration. Accordingly, while embodiments of the invention are susceptible to various modifications and alternative forms, specific embodiments thereof are shown by way of example in the drawings and will herein be described in detail. It should be understood, however, that there is no intent to limit embodiments of the invention to the particular forms disclosed, but on the contrary, embodiments of the invention cover all modifications, equivalents, and alternatives falling within the spirit and scope of the disclosure.

Exemplary embodiments of the disclosure are directed to systems and methods for identifying IT outsourcing contract renewal risk ahead of contract expiration by taking into account client satisfaction survey results in the form of numeric scores, and client interview transcripts in the form of unstructured text. Embodiments of the disclosure use machine learning techniques to automatically process the transcripts to identify important topics of interest along with an associated sentiment for each topic. Each topic may be associated with a sentiment {negative (−1), neutral (0), positive (1)}. Embodiments of the disclosure can use the output of the sentiment analysis as an input, in addition to survey scores, to classify contract renewal risk. By using sentiment analysis to transform textual information into structured input, the classification accuracy of non-renewing contracts in particular is substantially enhanced. Moreover, the topics with negative sentiments identified by the sentiment analysis can shed light on the root causes of problems leading to contract nonrenewal.

### Understanding Data

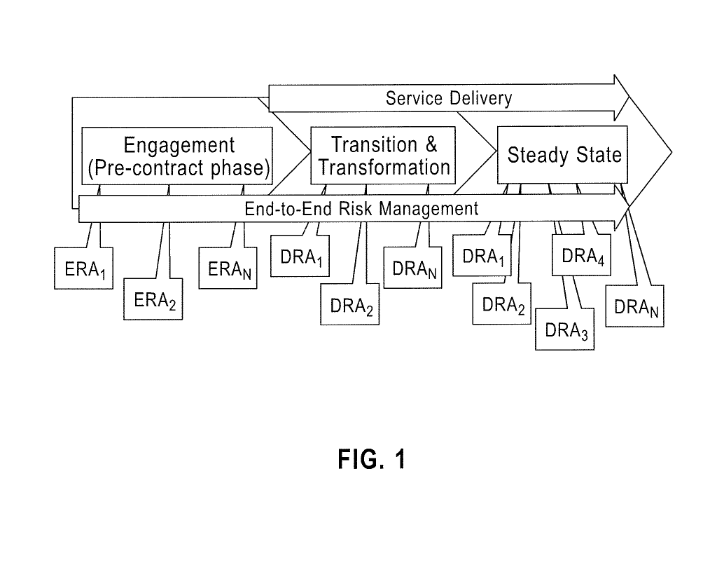

FIG. 1 depicts a typical IT outsourcing contract lifecycle and end-to-end risk assessment, including a pre-contract engagement phase, and a transition and transformation phase and a steady state phase during contract service delivery. In the figure, ERAs represent various Engagement Risk Assessments and DRAs represent Delivery Risk Assessments. The end-to-end risk management performed along the service lifecycle entails a series of risk assessments both prior to and after contract signature. Embodiments of the disclosure focus on the service delivery phase, and, in particular, the external assessments conducted before nearing contract expiration. Embodiments of the disclosure use the following CSAT data for analysis:
client survey data: comprises 23 questions, where the client gives a score of 1(lowest satisfaction) to 10 (highest satisfaction) for each question. An overall score of 1 (lowest) to 10 (highest) is either provided by the client or calculated out of all answers.
interview transcript data: comprises detailed versions of the same 23 questions where the client is asked to elaborate on specific issues or provide general comments.

Embodiments of the disclosure seek to understand whether the sentiments extracted from the client interviews can further enhance a correlation between CSAT survey scores and contract renewal decisions made by the clients. Embodiments of the disclosure can automatically extract relevant topics and identify their associated sentiments to reduce (and eventually eliminate) manual work and interpretation.

### Sentiment Analysis

A sentiment analysis according to an embodiment of the disclosure can identify and extract important topics and their associated sentiments from unstructured text input. Embodiments of the disclosure use the client interview transcripts as the input and receive a {−1, 0, 1} sentiment score for each identified topic as output. Embodiments of the disclosure use a simple algorithm to average the sentiments across all identified topics for a given client to yield an overall client sentiment score. In a domain specific setting, domain experts can provide input regarding the importance of each topic, such as timeliness vs. cost for a given client, and such insights can be used to create different weights for each topic when calculating the sentiment score. The resulting sentiment score is used in conjunction with CSAT scores to classify contract renewals.

Although the sentiments are bundled together into a sentiment risk score for each client for practical purposes, the information carried by individual topics and their associated sentiments are still useful for understanding reasons for potential contract termination.

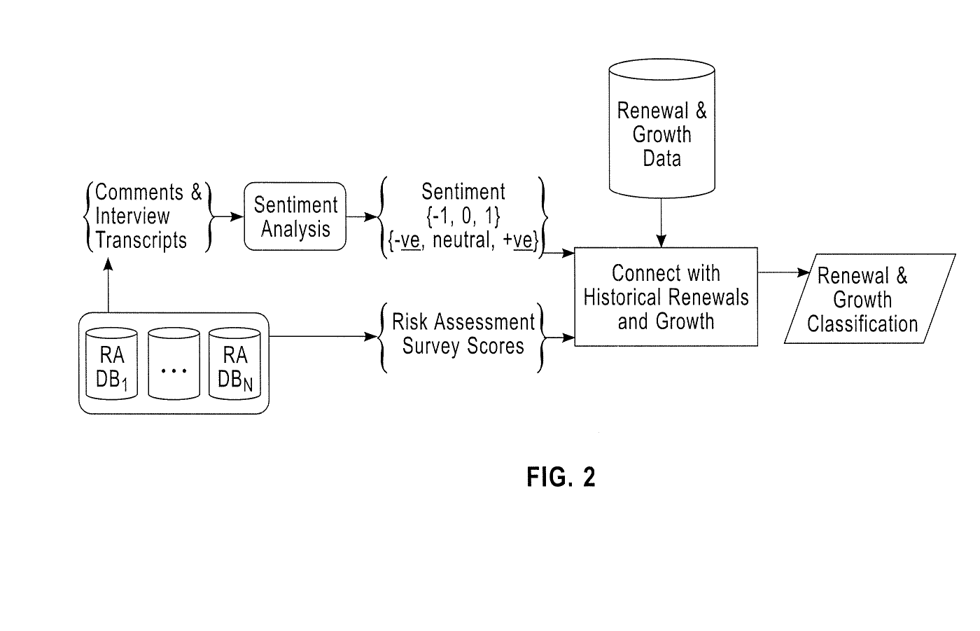

FIG. 2 depicts a contract renewal classification based on survey scores and client sentiments, according to an embodiment of the disclosure. Referring now to FIG. 2, comments and interview transcripts, and risk assessment survey scores can be stored in one of more databases, such as risk assessment database RA DB₁ to RA DB_{N} illustrated in the figure. The comments and interview transcripts serve as input to a sentiment analysis program, which can output sentiments whose values are can be represented as {−1, 0, 1} or {−ve, neutral, +ve}, which respectively represent a negative sentiment, an neutral sentiment, and a positive sentiment. The sentiment results and risk assessment survey scores are then combined by an analysis program in conjunction with historical renewal and growth data to yield a renewal and growth prediction model. According to embodiments, the renewal and growth data may be stored in another database. For a given contract that is up for expiration, the predictive model can read the comments and interview transcripts, and risk assessment survey scores from their respective databases to produce a prediction of renewal and growth, and an analysis of the potential root causes for non-renewal predictions. The renewal prediction takes on values of {−1, 1} for “not-renewed” or “renewed”, respectively. The growth prediction are for the case of the contract being renewed, and is expressed as values of {−1, 0, 1} for respectively, reduced services provided by the contract, no change in the services provided, and additional services provided in the contract.

### Extracting Topics and Sentiments

To understand sentiments in survey data, embodiments will first identify the topics on which the sentiments are expressed. For example, in the response “Mr. John Smith is very pleased with the responsiveness of company XYZ.”, the sentiment ‘very pleased’ should be related to the topic ‘responsiveness’. To that end, embodiments first identify topics, such as ‘responsiveness’, and sentiment phrases, such as ‘very pleased’.

According to an embodiment of the disclosure, a hypothesis testing method is used to identify these topics and sentiment phrases. Given a text input, a goal is to find a set of words that are indicative of and unique to the domain from which the text originates. Common words such as ‘people’ or ‘said’ are likely to be domain independent and thus are not good indications of topic. On the other hand, words such as ‘proactive’ or ‘innovation’ tend to be domain specific and it is these words that are targeted. To discern domain-specific words, embodiments of the disclosure use a set of texts from a completely different domain, such as publicly available UN data, to serve as negative examples. According to an embodiment of the disclosure, given two texts, each from a different domain, log-likelihood hypothesis testing is used to determine which domain each word relates to. For example, general words such as ‘have’, ‘people’ will have close scores coming from either domain, whereas specific words such as ‘proactive’ will score higher in one domain than the other. According to an embodiment of the disclosure, after the words are scored, the top words are selected as domain-specific words.

Because topics are usually expressed by nouns and sentiment by adjectives, a word list gathered after a hypothesis testing according to an embodiment of the disclosure may be further constrained by selecting nouns for topic words and adjectives for sentiment words.

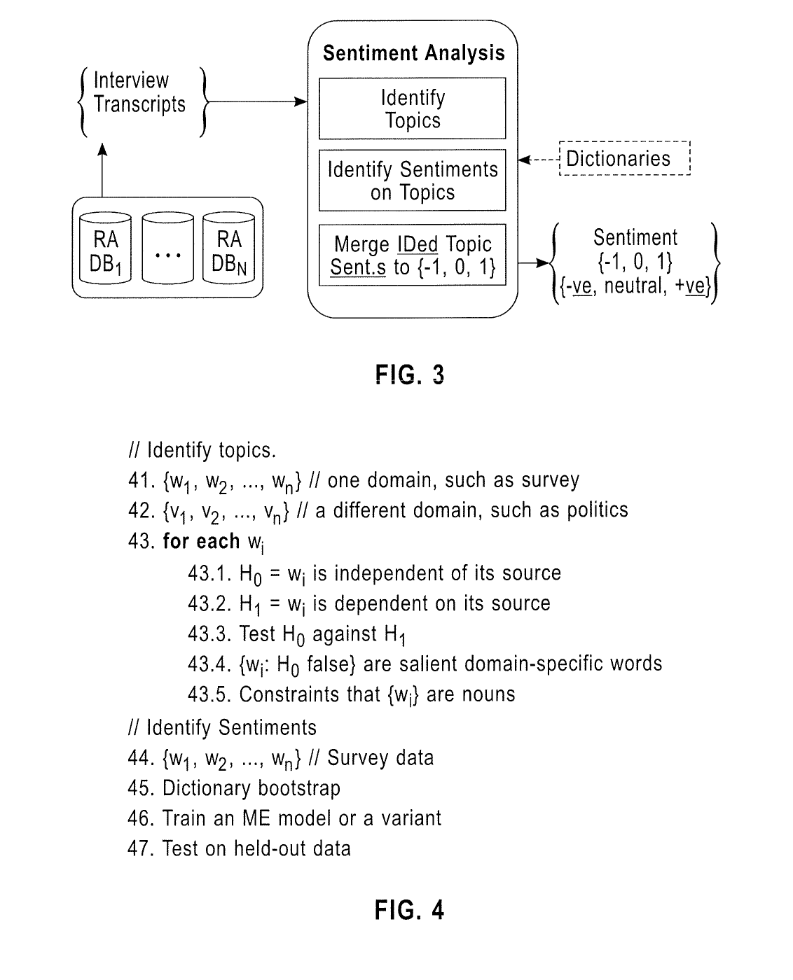

FIG. 3 is an overview of sentiment analysis from unstructured text, according to embodiments of the disclosure. According to embodiments of the disclosure, sentiment analysis can use machine learning (ML) techniques to automatically identify topics on all comments and interview transcripts that show sentiments, such as effort, skill, efficiency, responsiveness, timeliness, etc. Rich resources, such as domain specific dictionaries, and ML techniques can be used for automatically identifying sentiments in the comment topics. There are three basic categories of sentiments: positive, negative, and neutral, which can be refined into five categories: (1) very positive, (2) positive, (3) neutral/don't know, (4) negative, and (5) very negative. There could be many topics identified that have associated sentiments. These sentiments can be either negative, neutral, or positive, and some sentiments could be more heavily weighted than others. The sentiment results derived from the comments and transcripts can be merged and unified to arrive at a single overall sentiment value.

FIG. 4 is an algorithmic view of a method of sentiment analysis, according to an embodiment of the disclosure. According to embodiments of the disclosure, an approach for obtaining sentiments from comments includes identifying topics, and then identifying sentiments. Identifying topics according to embodiments of the disclosure includes obtaining domain specific comments {w₁, w₂, . . . wₙ} for a given domain A, and then determining which topics are specific to a given domain A. This can be done with some negative examples, i.e. some non-A words {v₁, v₂, . . . vₙ} from completely different domains, such as B, C, etc. Then, for each topic wᵢ identified for domain A, one seeks to prove one of two initial hypotheses: either H₀, that topic wᵢ is independent of its domain source, or H₁, that the topic depends on its source, subject to the constraint that the topics {wᵢ} are nouns. If H₀ is true, i.e., a topic is independent of its source, it can be excluded from further analysis. On the other hand, if H₁ is true, the topic is kept and is associated with its source.

Identifying sentiments according to embodiments of the disclosure includes obtaining domain specific topics {t₁, t₂, . . . tₙ} for a given domain A, and bootstrapping sentiments using the risk assessment and sentiment scores associated with each topic. If the sentiment associated with a topic is unclear, the risk assessment score can be used to infer the associated assessment. In this way, using a subset of the comments and interview transcripts as a training set, a machine learning (ML) model can be built to associates different topics with their sentiments. This ML model can be tested on the held-out data not used for training, and the resulting model can be used for future cases of extracting sentiments from comments.

### Predictive Model

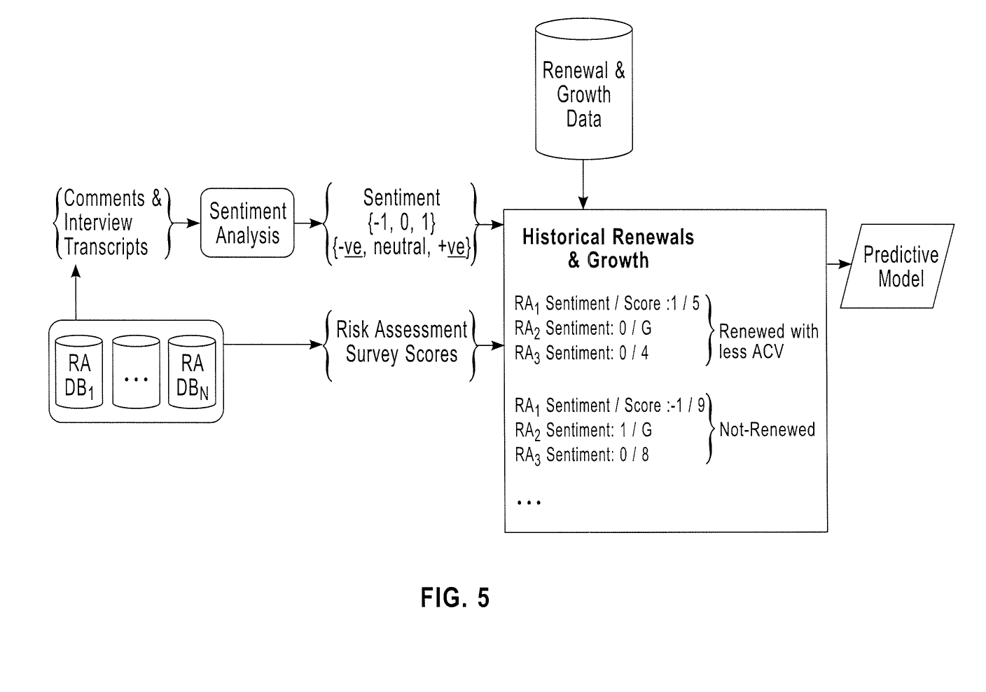

FIG. 5 illustrates details of a predictive model, according to embodiments of the disclosure. A predictive model according to embodiments of the disclosure can predict (1) whether a contract is likely to be renewed, (2) if it is not likely to be renewed, what the possible reasons are, and (3) if it is likely to be renewed, how much growth can be expected. According to embodiments of the disclosure, growth is defined as: (1) the contract was renewed and grew in Annual Contract Value (ACV) or Request For (new/additional) Services (RFS), (2) the contract was renewed and stayed the same in ACV or RFS, or (3) the contract was renewed and has less ACV and/or RFS.

Examples of contracts that are renewed and not-renewed are presented in the “Historical Renewals & Growth” box of FIG. 5. The box displays two sets of risk assessment/sentiment scores: the upper set for a contract that was renewed, and the lower set for a contract that was not renewed. Risks assessments and sentiments can be scored in various ways. For example, the upper RA₁ sentiment/score is 1/5, where the sentiment is 1 (positive) and the RA score is 5 from a score range of 1 . . . 10, where a higher value indicates more risk. Recall that sentiment takes on values of {−1,0,1}. The upper RA₂ sentiment/score is 0/G, where here the RA score is one of red (R), amber (A), and green (G) that respectively represents high risk, neutral risk, and low risk. The upper RA₃ is sentiment/score is 0/4, where the RA score range is 0 . . . 20. For the first contract in the Figure, since the three sentiments are either neutral or positive, and risk scores indicate a relatively low risk, the contract associated with these three sets of scores was renewed, but with fewer services for a lower annual contract value. Referring to the lower set of scores that belong to the second example contract in the Figure, there is a positive, a neutral, and a negative sentiment, along with 2 of the 3 RA scores indicating a relatively high risk. The contract associated with this set of scores was not renewed. The DB contains a large amount of historical contract risk assessment and sentiment data in this fashion and such data is analyzed to yield a predictive model.

### Experiments

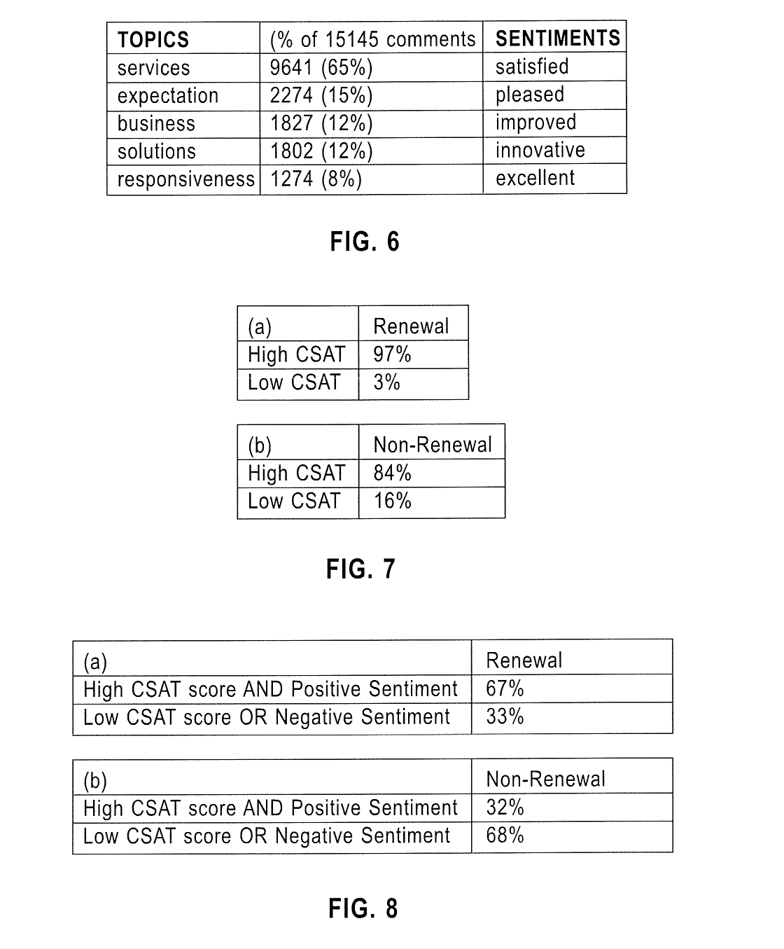

To evaluate the accuracy of a sentiment analysis according to an embodiment of the disclosure, results are compared against human-labeled data. The human-labeled data includes CSAT interview transcripts from about 100 contracts that have been manually examined to find the top 10 most relevant topics. An algorithm according to an embodiment of the disclosure is run on a superset of the human-labeled data that includes 570 historical contracts, which comprise 15,145 paragraphs (or comments) or 739,690 words. The results show that an algorithm according to an embodiment of the disclosure was able to find 9 of the 10 most relevant topics that match the human labels. FIG. 6 is a table depicting example topics with positive sentiments, with topics shown on the left hand side. A fully automated approach according to an embodiment of the disclosure gives 90% accuracy in determining the relevant topics.

Another step according to an embodiment of the disclosure is assessing the accuracy of the sentiments identified with these topics. For 52 contracts, a manual correction was performed on the sentiments due to a lack of sufficient negative sentiment examples in the training data. However, such corrections serve two purposes. First, a high-quality sentiment would yield a more accurate results for risk analysis. And second, this annotated corpus becomes the basis for future machine learning analysis. The fully automated topic identification we have implemented is crucial to incrementally building domain specific knowledge through this method without having to build manual dictionaries from scratch.

In another step according to an embodiment of the disclosure, the automatically identified topics with negative sentiments can be used to identify root causes of potential contract termination for proactive risk management. For example, if a contract renewal risk assessment indicates that a client is not likely to renew their contract, the sentiment analysis can provide potential reasons in the form of {topic/sentiment} pairs, such as {timeliness/poor} or {cost/high}, to allow the service provider to use these insights during contract renegotiations.

### Understanding the Impact of Client Sentiments on Contract Renewals

For an experiment according to an embodiment of the disclosure, 52 historical IT outsourcing contracts whose renewal outcomes are already known (renewed or not-renewed) were selected. Each contract has 4 years worth of client satisfaction data, which comprise yearly interviews and surveys. An initial analysis showed that the overall CSAT score collected in the year prior to contract expiration holds the most relevant information for identifying contract renewal and was, therefore, used for analysis. The results are shown as percentages to comply with confidentiality requirements imposed on the contract renewal data.

As mentioned above, a goal according to an embodiment of the disclosure is to understand whether CSAT interview transcripts can be used in conjunction with CSAT survey scores to enhance classification accuracy for contract renewal decisions. For an analysis according to an embodiment of the disclosure, the overall CSAT score were examined for the 52 service contracts and their contract renewal decisions were analyzed. The initial results, shown in FIG. 7(a), demonstrate that 97% of the service contracts that were renewed had achieved high CSAT scores, as expected. However, by looking at the high CSAT scores also observed for non-renewals, shown in FIG. 7(b), it becomes clear that CSAT scores alone have little value in identifying non-renewing service contracts. An analysis according to an embodiment of the disclosure shows that only 16% of the non-renewals can be correctly classified through the overall CSAT survey scores. As service providers are mainly interested in the early identification of non-renewals, other experiments according to embodiments of the disclosure focuses on the improvement of non-renewing service contract classification.

### The Role of Client Sentiment in Contract Renewal Classification

It is known in the art that data collected from surveys is “only as meaningful as the answers the survey respondents provide”. In other words, the reliability or accuracy of survey responses may vary significantly from one respondent to another. This means that surveys might inaccurately measure beliefs or behaviors, which introduces doubt into the validity of survey data and the analytical results from this data.

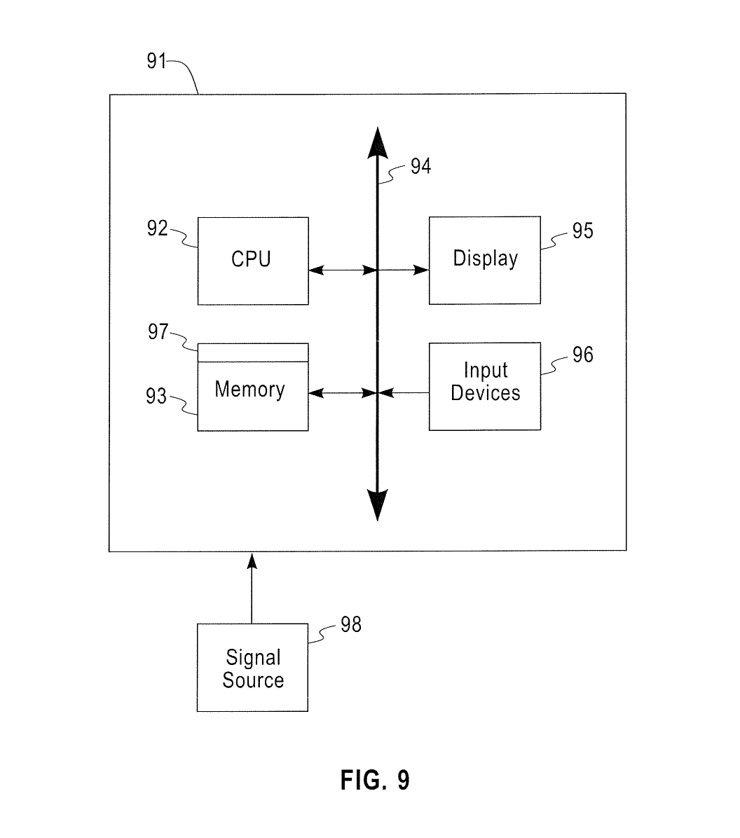

Although CSAT is not specifically designed to predict contract renewal likelihood, the above arguments agree with findings on client satisfaction data shown in FIG. 7. Embodiments of the disclosure can supplement CSAT survey data with client sentiments hidden in the unstructured interview text to help improve the correlation between CSAT results and contract renewal decisions. It was described above how important topics and their associated sentiments can be extracted from the unstructured interviews. Here, FIGS. 8(a)-(b) show a classification of renewed and non-renewing contracts based on sentiments extracted from interview data in conjunction with CSAT scores for classifying contract renewals and nonrenewals.

Based on additional input provided through a sentiment analysis according to an embodiment of the disclosure, a correct classification of nonrenewals of the same data set has improved from 16% to 68%, by comparing FIGS. 7(b) and 8(b). Note that this is at the expense of reducing the classification accuracy of renewals from 97% to 67%. Nevertheless, due to the improvement of the non-renewal classification, the overall accuracy has also improved from 57% to 68%. Since from a practical risk management perspective the focus is on detecting potential non-renewals, one may conclude that using an output provided by a sentiment analysis according to an embodiment of the disclosure, in conjunction with CSAT scores, provides an improvement.

Another, related finding from comparing FIGS. 7(a) and 8(a), is that a fraction of service contracts that have received low CSAT scores and are classified as renewals went up, from 3% to 33%, when sentiment analysis is included. This is because a sentiment analysis according to an embodiment of the disclosure can reveal negative information not captured by the CSAT score. From a risk management perspective this increases the attention brought to such service contracts, along with actionable mitigations, for proactive risk elimination.

### System Implementations

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 9 is a block diagram of an exemplary computer system for implementing a method for predicting contract erosion and renewal risk ahead of contract expiration. Referring now to FIG. 9, a computer system 91 for implementing the present invention can comprise, inter alia, a central processing unit (CPU) 92, a memory 93 and an input/output (I/O) interface 94. The computer system 91 is generally coupled through the I/O interface 94 to a display 95 and various input devices 96 such as a mouse and a keyboard. The support circuits can include circuits such as cache, power supplies, clock circuits, and a communication bus. The memory 93 can include random access memory (RAM), read only memory (ROM), disk drive, tape drive, etc., or a combinations thereof. The present invention can be implemented as a routine 97 that is stored in memory 93 and executed by the CPU 92 to process the signal from the signal source 98. As such, the computer system 91 is a general purpose computer system that becomes a specific purpose computer system when executing the routine 97 of the present invention.

The computer system 91 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been described in detail with reference to exemplary embodiments, those skilled in the art will appreciate that various modifications and substitutions can be made thereto without departing from the spirit and scope of the invention as set forth in the appended claims.

1. A method for predicting contract renewal ahead of contract expiration comprising the steps of:
receiving comments and interview transcripts by a sentiment analysis program to generate sentiments, wherein said comments and interview transcripts are received from a plurality of clients who are contractees to one or more service contracts;
combining said sentiments with contract assessment survey scores and historical renewal and growth data for said service contracts to generate a contract renewal and growth prediction model;
providing a contract that is up for expiration to the predictive model; and
providing the comments, interview transcripts, and risk assessment survey scores to the predictive model, wherein the predictive model outputs a prediction of renewal and growth for said contract up for expiration, and an analysis of root causes for the predictions.

2. The method of claim 1, wherein generating sentiments comprises:
providing a first set of comments specific to a first domain;
providing a second set of comments specific to a second domain;
determining a set of topics for the first domain using the second set of comments as negative examples with respect to the first domain; and
determining, for each topic in the set of topics, whether the topic is independent of its domain, wherein if said topic is independent of its domain, said topic is removed from the set of topics.

3. The method of claim 2, further comprising using log-likelihood hypothesis testing to determine to which of said first and second domains each said topic belongs.

4. The method of claim 2, wherein each topic in the set of topics is a noun.

5. The method of claim 2, further comprising bootstrapping sentiments from the set of topics for the first domain using sentiment scores associated with each topic and said contract assessment survey scores, wherein if a sentiment associated with a topic is unclear, using contract assessment survey scores to infer the associated assessment.

6. The method of claim 1, further comprising using machine learning techniques to determine topics from said comments, and to identify sentiments associated with each topic.

7. A method for predicting contract renewal ahead of contract expiration comprising the steps of:
receiving comments and interview transcripts by a sentiment analysis program to generate sentiments, wherein said comments and interview transcripts are received from a plurality of clients who are contractees to one or more service contracts;
providing a first set of comments specific to a first domain;
providing a second set of comments specific to a second domain;
determining a set of topics for the first domain using the second set of comments as negative examples with respect to the first domain; and
determining, for each topic in the set of topics, whether the topic is independent of its domain, wherein if said topic is independent of its domain, said topic is removed from the set of topics.

8. The method of claim 7, further comprising bootstrapping sentiments from the set of topics for the first domain using sentiment scores associated with each topic and said contract assessment survey scores, wherein if a sentiment associated with a topic is unclear, using contract assessment survey scores to infer the associated assessment.

9. The method of claim 8, further comprising:
combining said sentiments with contract assessment survey scores and historical renewal and growth data for said service contracts to generate a contract renewal and growth prediction model;
providing a contract that is up for expiration to the predictive model; and
providing the comments, interview transcripts, and risk assessment survey scores to the predictive model, wherein the predictive model outputs a prediction of renewal and growth for said contract up for expiration, and an analysis of root causes for the predictions.

10. A non-transitory program storage device readable by a computer, tangibly embodying a program of instructions executed by the computer to perform the method steps for predicting contract renewal ahead of contract expiration, the method comprising the steps of:
receiving comments and interview transcripts by a sentiment analysis program to generate sentiments, wherein said comments and interview transcripts are received from a plurality of clients who are contractees to one or more service contracts;
combining said sentiments with contract assessment survey scores and historical renewal and growth data for said service contracts to generate a contract renewal and growth prediction model;
providing a contract that is up for expiration to the predictive model; and
providing the comments, interview transcripts, and risk assessment survey scores to the predictive model, wherein the predictive model outputs a prediction of renewal and growth for said contract up for expiration, and an analysis of root causes for the predictions.

11. The computer readable program storage device of claim 10, wherein generating sentiments comprises:
providing a first set of comments specific to a first domain;
providing a second set of comments specific to a second domain;
determining a set of topics for the first domain using the second set of comments as negative examples with respect to the first domain; and
determining, for each topic in the set of topics, whether the topic is independent of its domain, wherein if said topic is independent of its domain, said topic is removed from the set of topics.

12. The computer readable program storage device of claim 11, the method further comprising using log-likelihood hypothesis testing to determine to which of said first and second domains each said topic belongs.

13. The computer readable program storage device of claim 11, wherein each topic in the set of topics is a noun.

14. The computer readable program storage device of claim 11, the method further comprising bootstrapping sentiments from the set of topics for the first domain using sentiment scores associated with each topic and said contract assessment survey scores, wherein if a sentiment associated with a topic is unclear, using contract assessment survey scores to infer the associated assessment.

15. The computer readable program storage device of claim 10, the method further comprising using machine learning techniques to determine topics from said comments, and to identify sentiments associated with each topic.

16. A non-transitory program storage device readable by a computer, tangibly embodying a program of instructions executed by the computer to perform the method steps for predicting contract renewal ahead of contract expiration, the method comprising the steps of:
receiving comments and interview transcripts by a sentiment analysis program to generate sentiments, wherein said comments and interview transcripts are received from a plurality of clients who are contractees to one or more service contracts;
providing a first set of comments specific to a first domain;
providing a second set of comments specific to a second domain;
determining a set of topics for the first domain using the second set of comments as negative examples with respect to the first domain; and
determining, for each topic in the set of topics, whether the topic is independent of its domain, wherein if said topic is independent of its domain, said topic is removed from the set of topics.

17. The computer readable program storage device of claim 16, the method further comprising bootstrapping sentiments from the set of topics for the first domain using sentiment scores associated with each topic and said contract assessment survey scores, wherein if a sentiment associated with a topic is unclear, using contract assessment survey scores to infer the associated assessment.

18. The computer readable program storage device of claim 17, the method further comprising:
combining said sentiments with contract assessment survey scores and historical renewal and growth data for said service contracts to generate a contract renewal and growth prediction model;
providing a contract that is up for expiration to the predictive model; and
providing the comments, interview transcripts, and risk assessment survey scores to the predictive model, wherein the predictive model outputs a prediction of renewal and growth for said contract up for expiration, and an analysis of root causes for the predictions.
